(19) United States
(12) Patent Application Publication
(10) Pub. No.: US 2011/0193872 A1
(43) Pub. Date: Aug. 11, 2011

(54) CONTROL SYSTEM FOR HYBRID DAYLIGHT-COUPLED BACKLIGHTS FOR SUNLIGHT VIEWABLE DISPLAYS

(75) Inventors: Rolf W. Biernath, Wyoming, MN (US); Scott E. Brigham, Maplewood, MN (US); Martin Kristoffersen, Maplewood, MN (US)

(73) Assignee: 3M Innovative Properties Company

(21) Appl. No.: 12/702,608

(22) Filed: Feb. 9, 2010

(51) Int. Cl. G09G 3/36; G09G 5/02

(52) U.S. Cl. 345/589; 345/207; 345/102

(57) ABSTRACT

A control system for a hybrid daylight-coupled display having an LCD panel, a diffuser, and a curved reflector behind the LCD panel, and an active backlight for providing backlighting from an active light source. For passive backlighting, the diffuser transmits daylight to the reflector, which reflects the daylight to the LCD panel and provides substantially uniform distribution of the daylight on the LCD panel for backlighting it. The control system comprises a sensor unit detecting ambient light level surrounding the LCD display and another sensor unit detecting backlights provided by the active backlight and the daylight. The control system adjusts the brightness of the active backlight based on data from the two sensor units.

### BACKGROUND

Sunlight viewability of digital displays, such as a liquid crystal display (LCD), is increasing in business importance as such displays become more ubiquitous. Advertisers desire the ability to use digital media in outdoor environments, and consumers would like their electronics to be usable everywhere. Current solutions to the outdoor sunlight visibility problem fall short because of insufficient brightness or excessive power consumption and its resultant heat load. For example, one solution achieves 2000 nits brightness by using 720 three watt LEDs in a 40 inch display, which requires a liquid cooling system to dissipate the 2.1 kW of heat. Also, the system weighs 110 lbs., a significant amount of weight for such a display.

### SUMMARY

A hybrid daylight-coupled display, consistent with the present invention, includes an LCD panel having a top side and a bottom side, a diffuser having a front edge adjacent to the top side of the LCD panel and having a back edge, a curved reflector having a top side adjacent to the back edge of the diffuser and having a bottom side adjacent to the bottom side of the LCD panel, an active backlight for providing active backlighting, and a control system. The diffuser transmits daylight to the reflector to provide passive backlighting, and the active backlight transmits active backlight to the reflector. The reflector reflects backlights including the passive backlight and the active backlight to the LCD panel and provides backlighting to the LCD panel. The control system comprises a first sensor unit detecting the ambient light level surrounding the LCD panel, a second sensor unit positioned between the LCD panel and the reflector detecting a light level for total backlights including the active backlight and the passive backlight, and a processor. The processor determines a control signal based on data from the first and second sensor units and adjusts the active backlight's light level based on the control signal.

A stacked hybrid daylight-coupled display, consistent with the present invention, includes an LCD panel having a top side and a bottom side, a diffuser having a front edge adjacent to the top side of the LCD panel and having a back edge, a first curved reflector having a top side adjacent to the back edge of the diffuser and having a bottom side adjacent to the mid-point of the LCD panel, a second curved reflector having a top side adjacent to the back edge of the diffuser and having a bottom side adjacent to the bottom side of the LCD panel, an active backlight for providing active backlighting, and a control system. The diffuser transmits daylight to the first and second reflectors to provide passive backlighting, and the active backlight transmits active backlight to the first and second reflectors. The first reflector reflects backlights including the passive backlight and the active backlight to a top portion of the LCD panel for providing backlighting, and the second reflector receives light transmitted through the first reflector and reflects the light to a bottom portion of the LCD panel for providing backlighting. The control system comprises a first sensor unit detecting the ambient light level surrounding the LCD panel, a second sensor unit between the first reflector and the second reflector detecting a light level for total backlights including the active backlight and passive backlight, and a processor. The processor determines a control signal based on data from the first and second sensor units and adjusts the active backlight's light level based on the control signal.

### BRIEF DESCRIPTION OF THE DRAWINGS

The accompanying drawings are incorporated in and constitute a part of this specification and, together with the description, explain the advantages and principles of the invention. In the drawings,

FIG. 1 is a side view of a hybrid daylight-coupled LCD device having a control system that comprises two sensor units and a controller;

FIG. 2 is a perspective view of the hybrid daylight-coupled LCD device of FIG. 1;

FIG. 3 is a brightness control flowchart;

FIG. 4 is a side view of a hybrid daylight-coupled LCD device having a control system that comprises three sensor units and a controller;

FIG. 5 is a perspective view of the hybrid daylight-coupled LCD device of FIG. 4;

FIG. 6 is a side view of a stacked hybrid daylight-coupled LCD device having a control system;

FIG. 7 is a perspective view of the stacked hybrid daylight-coupled LCD device of FIG. 6;

FIG. 8 is a side view of a hybrid daylight-coupled LCD device having a control system and an active backlight cooling device;

FIG. 9 is a flowchart illustrating brightness control with user input;

FIG. 10 is a flowchart illustrating brightness control and cooling level control;

FIG. 11 is a side view of a hybrid daylight-coupled LCD device having a control system and a shutter;

FIG. 12 is a flowchart illustrating brightness control and shutter control; and

FIG. 13 is a flowchart illustrating display attribute control.

### DETAILED DESCRIPTION

The present invention now will be described more fully hereinafter with reference to the accompanying drawings, certain of which show embodiments of the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Using sunlight as a source of illumination for a display helps to save electrical power, enabling a more energy-efficient display. The daylight-coupled backlight provides a daylight-viewable solution that is potentially solar powered and also produces a high brightness display. At night-time or other low ambient light conditions, the backlight can be supplemented with an active light source. By using the sun to light the backlight, it saves a substantial power load and enables an energy efficient display, a daylight viewable solution that is potentially completely solar powered, and a high brightness display.

Daylight-coupled LCD devices can be used in a variety of outdoor settings for digital signage, traffic signage, or to display of other types of information. The devices can be housed in a kiosk or other types of enclosures depending upon, for example, a desired use of the devices. The devices can be used on bus shelters, sides of buildings, trucks, trailers, or other outdoor locations for advertisement or other information presentation. They can also be used in a variety of indoor settings to display information or advertisement in store-front windows, high-ambient mall courtyards, or other locations. They can also be used inside of a car to display information on the center stack, driver cluster or dashboard. They can be mounted on the backside of the headrests or from the ceiling to display entertainment within a vehicle. The devices can also be in a smaller form factor as well—display diagonals less than 7 inches. The display panels in the devices can be arranged in a portrait mode or a landscape mode for display of information.

The term LCD is used here to represent the variety of liquid crystal panels currently available on the market and those that may become available in the future, including, but not limited to conventional TN panels; PVA, MVA or OCB mode panels; and transflective panels. The term “LCD panel” includes a single LCD panel or multiple LCD panels mounted adjacent one another. Additionally, the LCD panels may be substituted with other backlit light-valve type displays, other backlit electronic displays, electronic signage, or static signage. Also, the LCD panels may be substituted with solar panels to enhance the amount of daylight upon the solar panels or allow the solar panels to be configured in varying orientations, or the LCD panels may be substituted with other devices requiring illumination. The backlight can be designed to be collapsible so that it functions as a more conventional backlight in its collapsed state, but by means of hinges, springs, or slides, rearranges to form the backlight described in the present specification. Additionally, it may be designed to be collapsible for purposes of transportation or storage.

Preferably, highly reflective specular films are used throughout the backlight cavity. However, optionally, diffusers may be added at various locations, such as behind the LCD panel, for example, to hide seams or interfaces between components. All diffusers in the system, including the entrance aperture, may be passive such as bead coated films and bulk diffuser plates, or they may be actively controlled such as PDLC (Polymer Dispersed Liquid Crystal) films or plates, for example.

Examples of various hybrid backlights are disclosed in the following: U.S. patent application Ser. No. 12/330155, entitled “Passive and Hybrid Daylight-Coupled Backlights for Sunlight Viewable Displays, and filed Dec. 8, 2008; and U.S. patent application Ser. No. 12/492166, entitled “Passive and Hybrid Daylight-Coupled N-Stack and Collapsible Backlights for Sunlight Viewable Displays, and filed Jun. 26, 2009, both of which are incorporated herein by reference as if fully set forth.

### Brightness Control System for Hybrid Daylight-Coupled Display

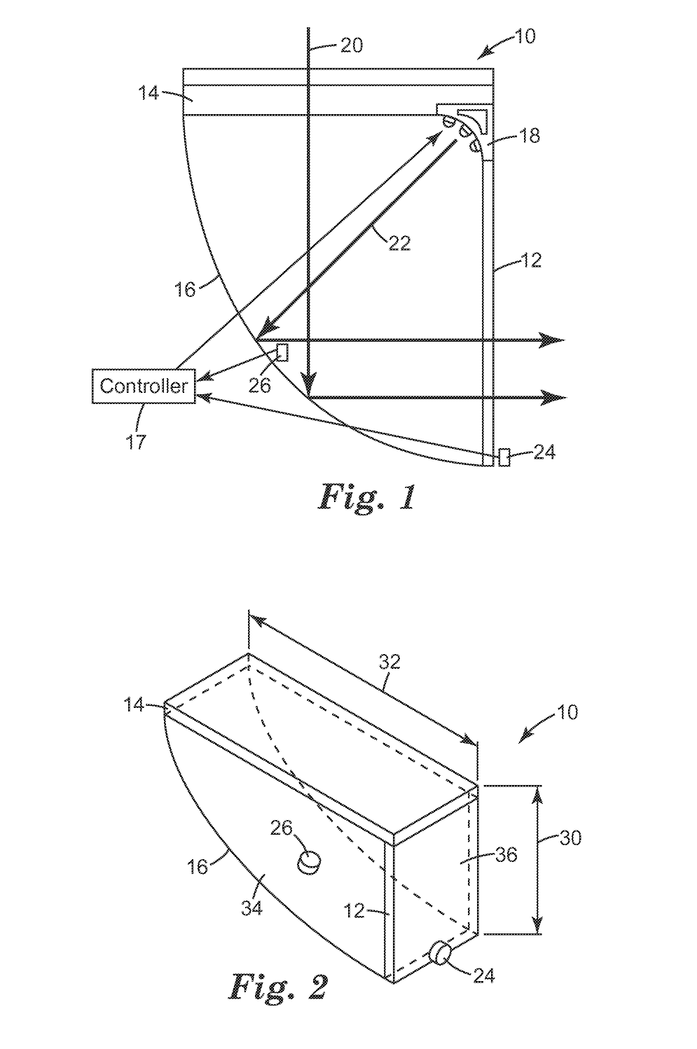

FIG. 1 is a side view of a hybrid daylight-coupled LCD device 10 with a control system and FIG. 2 is a perspective view of the hybrid daylight-coupled LCD device 10 with a control system. Device 10 includes an LCD panel 12, a diffuser 14, a curved reflector 16 having side panels 34 and 36, a first sensor unit 24, a second sensor unit 26, a controller 17, and an active backlight 18. Active backlight 18 can be located at the juncture of LCD panel 12 and diffuser 14. Active backlight 18 can be implemented within a corner bracket, for example. Device 10 has a height 30 and a depth 32.

As represented by arrow 20, for passive backlighting diffuser 14 transmits daylight to reflector 16, which reflects the light upon the LCD panel 12 in order to provide backlighting for the LCD panel. Device 10 is designed with a depth 32 and curvature of reflector 16 such that reflector 16 provides substantially uniform distribution of the reflected daylight onto LCD panel 12. With a circular shape for reflector 16, meaning that it forms a portion of a circle, the ratio of height 30 to depth 32 is approximately 1 to 1. In other embodiments, particularly if a turning film is used behind the LCD panel, the ratio of the height of the LCD panel to the depth of the diffuser is approximately 1 to 0.5. A stacked reflector configuration can realize a preferred ratio of 1 to 0.375. In device 10, and in other daylight-coupled LCD devices, diffuser 14 is preferably positioned at an angle of approximately 90° with respect to LCD panel 12, although the angle can be greater than 120° and can also be less than 90°.

For active backlighting, active backlight 18 transmits light to reflector 16 as represented by arrow 22 to be reflected upon LCD panel 12 for backlighting it. Active backlight 18 can be implemented with, for example, a light emitting diode (LED) bar. It can be preferable for back reflector 16 to have some degree of optical diffusion, such as gain-diffuser bead coating, microstructured diffuser coating, or other such diffusive overlay to aid in redirecting the light and hide the point light sources. It is preferable for the LEDs to have a narrow emission angle, such as 75° included angle white LEDs from Seoul Semiconductor. Optionally, diffusers may be added at various locations, such as behind the LCD panel, for example, to hide seams or interfaces between components.

Where multiple light sources are used, such as the three rows of LEDs 18, these light sources may be positionally uniformly distributed or variably distributed, they may be the same color or different colors, and they may be run at the same power or at varying powers to achieve the desired uniformity, color temperature, and view angle of the LCD panel 12. Multiple different types of light sources and configurations can be combined.

A sensor unit may comprise one or more sensors mounted at various locations in device 10. The first sensor unit 24 can detect the ambient light level surrounding the LCD panel. The second sensor unit 26 can detect the light level inside the backlight cavity and be used to determine the light level of total backlights, combining the passive backlight and active backlight when it is activated, projected on the LCD panel. In one embodiment, the first sensor unit 24 can be located at the face of the LCD panel, and the second sensor unit 26 can be located within the backlight cavity created by the LCD panel 12, the diffuser 14, and the curved reflector 16. In one embodiment, the first sensor unit 24 includes a sensor located at the bottom center of the LCD panel, and the second senor unit 26 includes a sensor located on the side panel 34. In another embodiment, the first sensor unit 24 can include more than one sensor located on the face of the LCD panel 12. In yet another embodiment, the second sensor unit 26 can include more than one sensor located inside the backlight cavity.

In one embodiment, at least one of the sensors in the first and the second sensor units comprises photometric sensors measuring illumination in terms of lux, which is radiation as the human eye sees it. A photometric sensor has a spectral response similar to human eyes, such as a Rohm BH1620FVC sensor. Sensors in the first and second sensor units, for example, can be sensors detecting photons, light sensors with color filters, temperature sensors, and airflow sensors.

In another embodiment, at least one of the two sensor units comprises a plurality of sensors, and each of the plurality of sensors measures the power in a particular spectral range. At the same time, the light source comprises a number of light sources, such as LEDs, each light source has a similar spectral range to one of the plurality of the sensors. The brightness of the light source with a particular spectral range is adjusted based on data from the sensor with the similar spectral range. For example, the first sensor unit may comprise sensors sensitive to red, green, and blue light respectively, and the LED light source may comprise red, green, and blue LEDs. The power of LEDs in a particular spectral range, such as red, is adjusted based on data from the sensor(s) sensitive to the similar spectral range.

The brightness of the active backlight 18 is automatically adjusted to provide adequate backlighting to the LCD panel 12. The LCD device is used under various light conditions including under the sun, under cloudy sky, or in night-time. The active backlight provides backlight supplementation to the LCD panel when the light level for passive backlight is not adequate. Using the second sensor unit 26 to provide feedback in determining adequate backlight compensation, the present control system adjusts the active backlight 18 with finer increment or decrement than a backlight control system using switches. On a rainy day, for example, half of the LEDs can be turned on or the LEDs can be turned on at half power. Thus, an automated system greatly reduces power consumption and heat generation. Furthermore, active backlight 18 can be activated when the passive backlight is not sufficient in providing backlighting, even if the daylight is strong. For example, when the sun directly shines on the face of the LCD panel, the active backlight is activated to compensate the glare on the LCD panel.

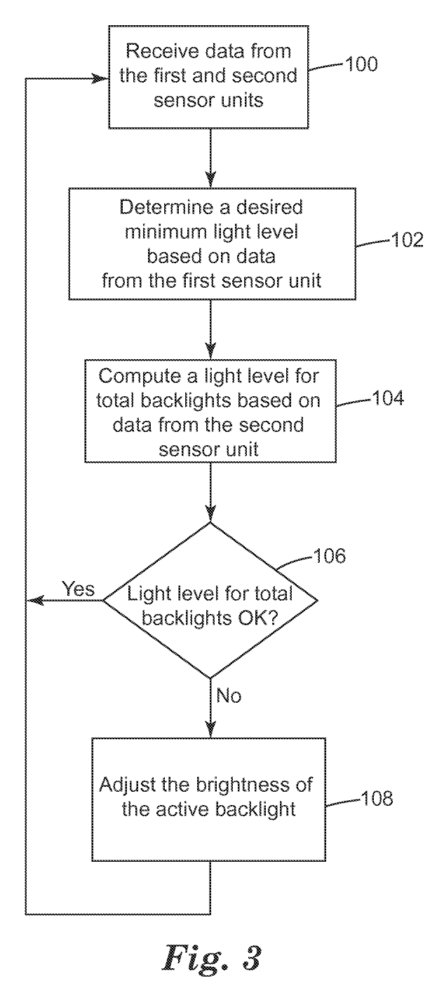

FIG. 3 illustrates an exemplary brightness control flowchart for the control system. Initially, controller 17 receives data from the first and the second sensor units (step 100). Next, the controller computes a desired minimum light level (SP), referred to as a desired luminance setpoint based on data from the first sensor unit 24 (step 102). Controller 17 also determines a light level of total backlights projected on the LCD panel (PV) based on data from the second sensor unit (step 104). A control signal is determined based on the comparison of the light level of total backlights projected on the LCD panel (PV) with the desired minimum light level (SP) (step 106). If the light level of total backlights projected on the LCD panel is not adequate, the brightness of the active backlight is adjusted according to the difference between PV and SP (step 108). For example, if PV is greater than SP, the power of the active backlight is reduced and the brightness of the active backlight is lowered; if PV is smaller than SP, the power of the active backlight is increased and the brightness of the active backlight becomes higher. Alternatively, adjustment is only made when the difference between SP and PV is greater than a particular threshold. Controller 17 could be a microcontroller, a PIC (Programmable Interface controller), a PID (Proportional-Integral-Derivative) controller, a microprocessor, a processor, or any other form of computing unit, implementing the method of FIG. 3 in software or firmware.

The second sensor unit 26 is placed inside the backlight cavity created by the diffuser 14, the reflector 16, and the LCD panel 12. The luminance level on the LCD panel is assumed to be proportional to the light level measured inside the cavity. In one embodiment, a scale factor can be determined by empirically measuring the actual luminance level of the LCD panel with a luminance meter and comparing the actual luminance level with data from the second sensor unit. In another embodiment, a scale factor can be determined by optical modeling of the LCD device. In addition, a scale factor can be determined by averaging scale factors obtained in various ambient light conditions, such as under the sun or in the dark. Furthermore, a scale factor may be adjusted to different values over time, to compensate for varying transmission of the panel over time, such as due to thermal fluctuations, aging of the LCD, or by design.

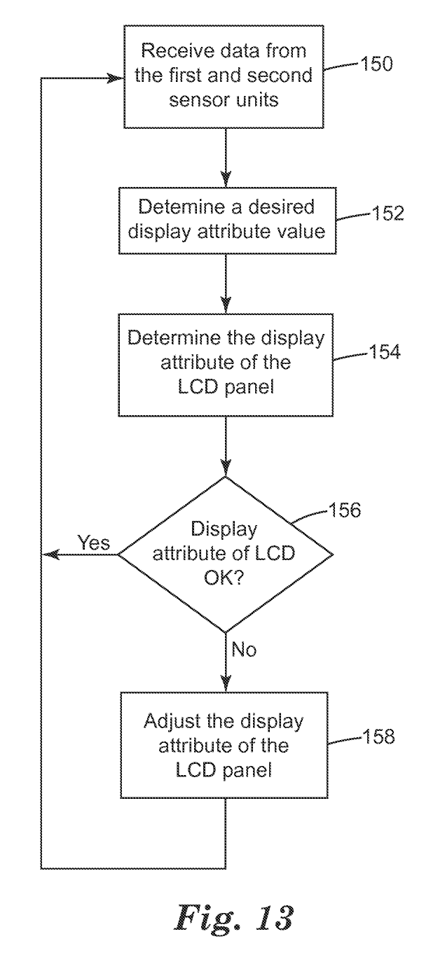

Besides controlling the brightness of the LCD panel, display attributes of the LCD panel can be adjusted to provide desirable visual performance. Display attributes include color temperature, hue, contrast ratio, color saturation, and other attributes. The display attributes of the LCD panel can be adjusted, for example, via the LCD control interface, by changing the color lookup tables in the LCD logic, or by controlling the LCD driver board. FIG. 13 illustrates an exemplary display attribute control flowchart. Initially, controller 17 receives data from the first and second sensor units (step 150). A desired display attribute value is either predetermined by user input or determined by data from the first sensor unit 14 (step 152). Next, the actual display attribute value of the LCD panel is determined by data from the first or the second sensor unit (step 154). For example, the hue of the LCD panel can be measured by a color sensor facing the LCD panel in the first sensor unit 14. Alternatively, the color temperature of the LCD panel can be measured by sensors inside the backlight cavity. A control signal is determined based on the difference between the desire display attribute value and the actual display attribute value (step 156). The display attribute of LCD panel is adjusted according to the control signal (step 158).

In one embodiment, the first sensor unit 14 may include a color sensor facing the LCD panel to measure the color temperature of the LCD panel. The measured value is compared with a predetermined desired color temperature value. If the color temperature is not adequate, a control signal can be determined by the controller and the color temperature setting of the LCD panel can be modified according to the control signal. In another embodiment, the first sensor unit 14 may include a color sensor to measure color temperature surrounding the LCD panel. The second senor unit 16 may include a color sensor to measure the color temperature reflected on the LCD panel. A control signal is determined based on data from the first and second sensor units. The LCD panel's color temperature setting is adjusted according to the control signal.

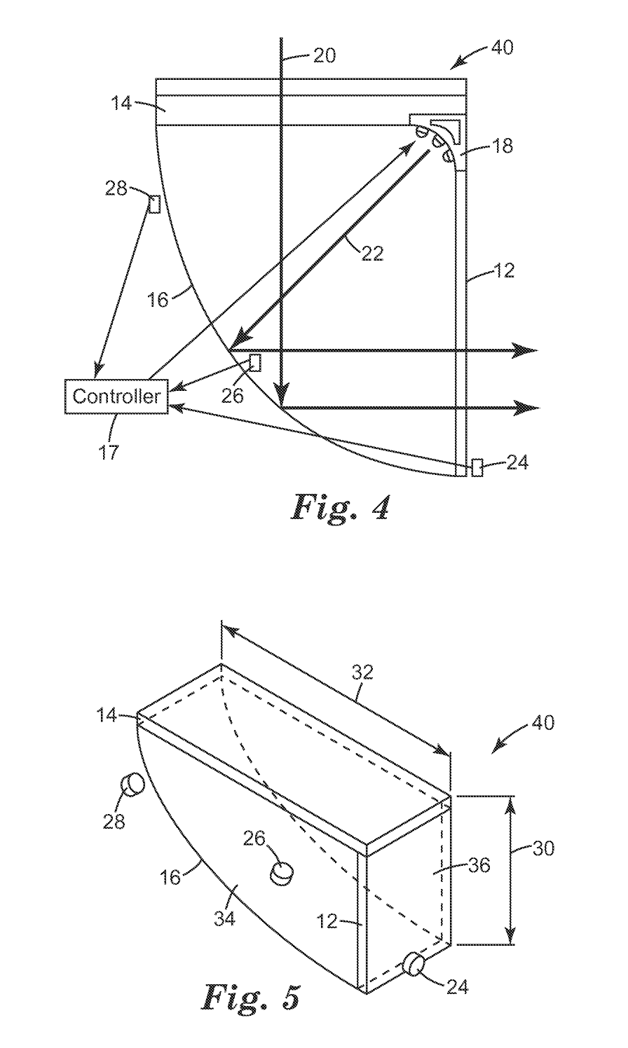

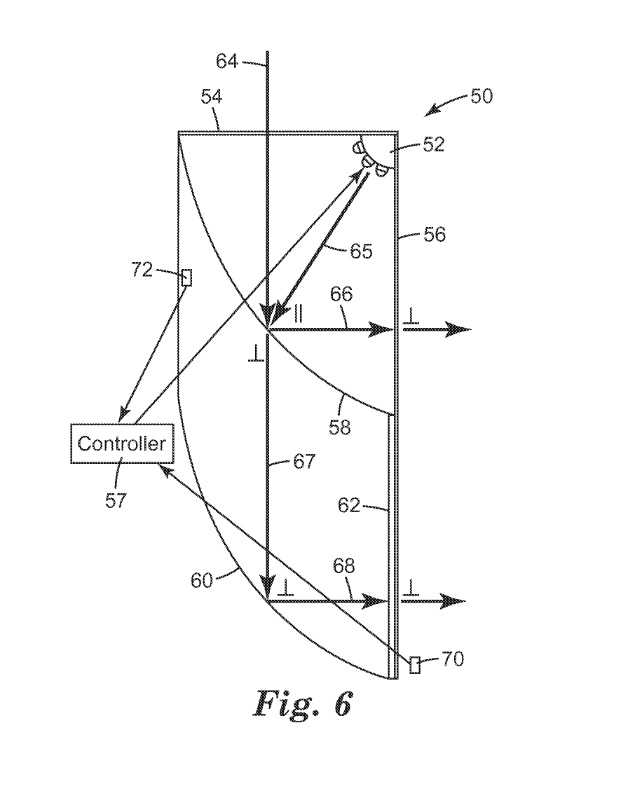

FIG. 4 is a side view of a hybrid daylight-coupled LCD device 10 with a control system having three sensor units and FIG. 5 is a perspective view of the hybrid daylight-coupled LCD device 10 with a control system. In one embodiment, the first sensor unit 24 can include a sensor on the face of the LCD panel, detecting the ambient light level at the front of the LCD panel. The second sensor unit 26 can detect the light level inside the backlight cavity. Furthermore, the third sensor unit 28 can include a sensor close to the back of the LCD device 10, detecting the ambient light level at the back of the LCD device. Controller 17 can determine the desired minimum light level based on data from the first and third sensor units. Then, controller 17 can determine a control signal using the method illustrated in FIG. 3, for example. Next, controller 17 can adjust the brightness of the active backlight 18 based on the control signal.

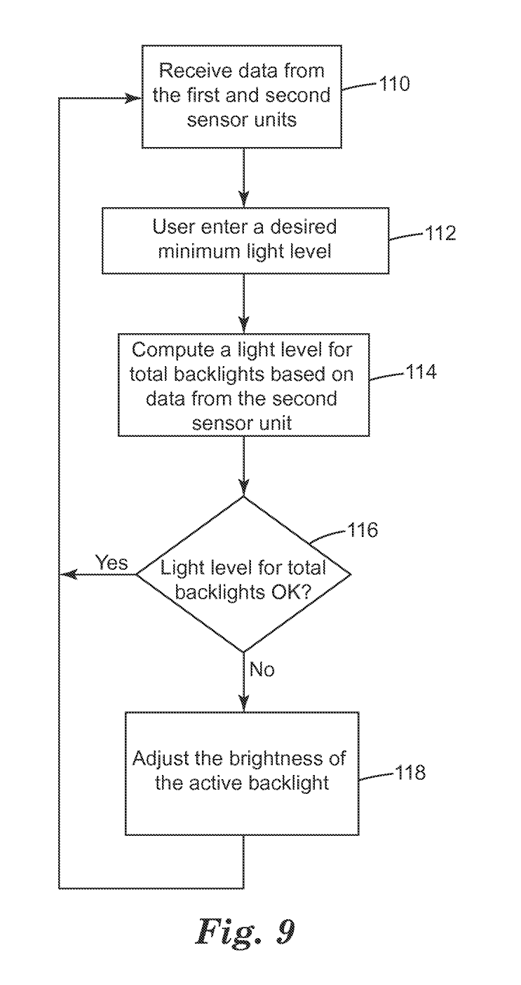

In one embodiment, as illustrated in FIG. 9, a user is allowed to adjust the desired minimum light level manually (step 112), instead of using data from the first sensor unit. Controller 17 can determine a control signal using the desired minimum light level manually set and data from the second sensor unit. Controller 17 can adjust the brightness of the active backlight 18 according to the control signal. A user may adjust the luminance setpoint via a user interface or a control panel.

Optionally, a shutter can be employed above or below diffuser 14 to prevent light leakage out of the diffuser 14 during times that the active lighting such as 18 is the primary source of light. The shutter can be electronically activated with a control system or manually activated, and it can be implemented electronically, electromechanically, thermomechanically, electrochemically, photochemically, or mechanically, combinations thereof and in other ways. The shutter may be implemented by a venetian blind for example, suspended to allow daylight to pass through it when open and reflect light back into the cavity when closed. Other implementations of the shutter include, but are not limited to, a barrier plate comprising a film or plate with a black matte surface facing upward and attached ESR film facing downward into the cavity; an electronic light valve; a mechanically rotatable baffle in a light pipe that feeds the top of the diffuser 14; an electrochromic window; or a photo-bleaching window (opposite of photochromic).

It is preferable that the sky-facing portion of shutter be dark with low reflectivity when in its closed state. It is preferable that the portion of shutter that faces in toward the cavity be highly reflective to efficiently return light toward the LCD panel 12.

### Brightness Control System for Stacked Hybrid Daylight-Coupled Display

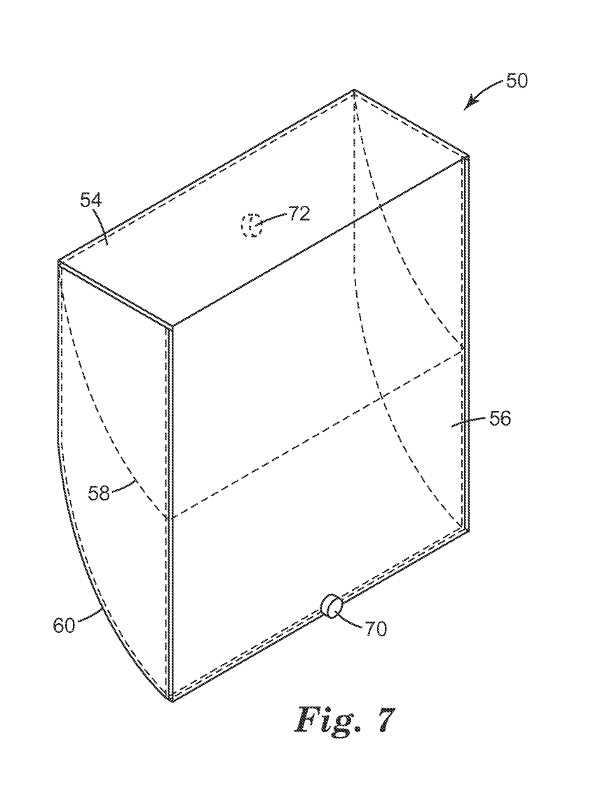

FIG. 6 is a side view of a stacked hybrid daylight-coupled LCD device 50 with a control system and FIG. 7 is a perspective view of the stacked hybrid daylight-coupled LCD device 50 with a control system. Device 50 includes an LCD panel 56, a diffuser 54, a first curved reflector 58, a second curved reflector 60, an active backlight 52, a first sensor unit 70, a second sensor unit 72, and a controller 57. The first curved reflector 58 is located between a back side of diffuser 54 and approximately a mid-point of LCD panel 56. The second curved reflector 60 is located between a back side of diffuser 54 and a bottom side of LCD panel 56. In one embodiment, the LCD panel 56 can comprise a plurality of LCD displays that is adjacent one another.

In one embodiment, the curved reflector 58 is implemented with reflective polarizing film, and reflector 60 is implemented with a specular reflector such as the ESR film or silvered or aluminized plastic. As represented by arrow 64, diffuser 54 transmits daylight to reflectors 58 and 60. At the same time, active backlight 52 transmits active backlight to reflect 58, as represented by arrow 65. Reflector 58 reflects light from the daylight and the active backlight of a first polarization 66 to LCD panel 56 to provide backlighting for an upper portion of LCD panel 56. Reflector 60 reflects light of a second polarization 68 to LCD panel 56 to provide backlighting for a lower portion of LCD panel 56. Reflector 58 transmits light of the second polarization 68 such that the reflectors 58 and 60 can provide substantially uniform distribution of the reflected backlight onto the top and bottom portions of LCD panel 56, respectively. Device 50 also includes a polarization rotator 62 positioned adjacent and behind the lower portion of LCD panel 56 to provide the correct polarization of light for backlighting the lower portion.

The first sensor unit 70 can detect the ambient light level surrounding the LCD panel. The second sensor unit 72 can detect the light level inside the backlight cavity and be used to determine the light level of total backlights, combining the passive backlight and active backlight when it is activated, projected on the LCD panel. In one embodiment, the first sensor unit 70 can be located on the face of the LCD panel. In one preferred embodiment, the first sensor unit 70 includes a sensor located at the bottom center of the LCD panel. Additionally, light in the cavity created by the LCD panel 56, the first reflector 58, and the second reflector 60, is more uniformly distributed than light in the cavity created by the LCD panel 56, diffuser 64, and the first reflector 58. Therefore, in one preferred embodiment, the second sensor unit 72 is located in the cavity created by the LCD panel 56, the first reflector 58, and the second reflector 60.

Device 50 can use the method of FIG. 3 to adjust brightness of the active backlight 52. For example, controller 57 receives data from the first sensor unit 70 and determines a desired minimum light level based on the data. Additionally, controller 57 receives data from the second unit 72 and determines a light level of total backlights projected on the LCD panel based on the data. Controller 57 further determines a control signal based on the comparison of the desired minimum light level with the light level of total backlights and adjusts the brightness of the active backlight 52 according to the control signal.

Control System for Hybrid Daylight-Coupled Display with a Cooling Device

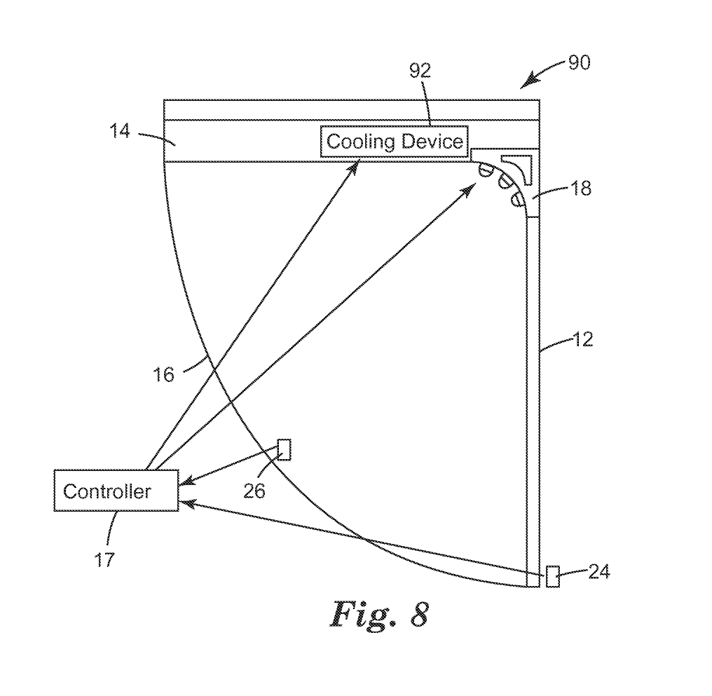

FIG. 8 is a side view of a hybrid daylight-coupled LCD device 90 with a control system and an active backlight cooling device. Device 90 includes an LCD panel 12, a diffuser 14, a curved reflector 16, a first sensor unit 24, a second sensor unit 26, a controller 17, an active backlight 18, and an active backlight cooling device 92. Controller 17 determines a control signal based on data from the first sensor unit 24 and the second sensor unit 26 and adjusts the power of active backlight according to the control signal, using the method of FIG. 3, for example. Controller 17 also adjusts the cooling level of the cooling device 92 based on the control signal. In one embodiment, cooling device 92 is a fan and the controller 17 can increase the fan speed when the power to the active backlight is increased.

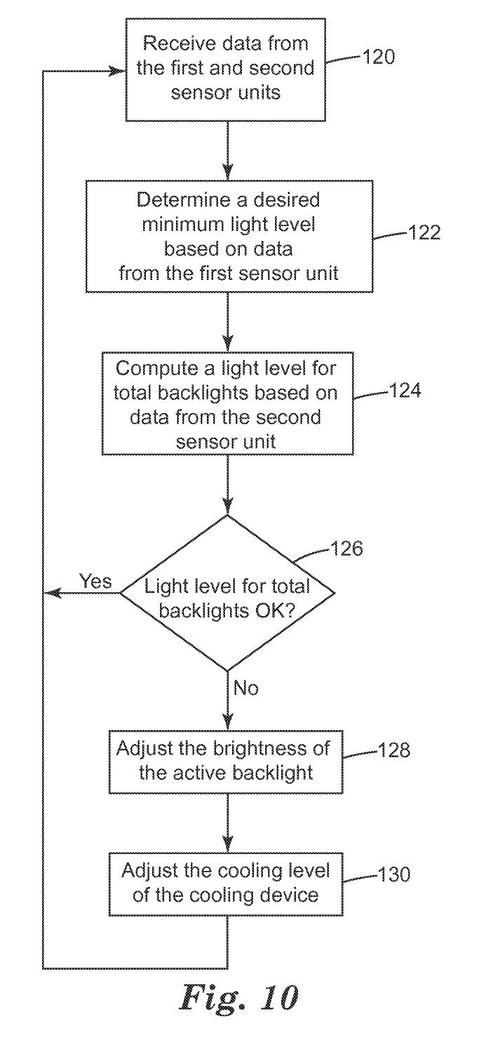

FIG. 10 illustrates an exemplary brightness control and cooling level control flowchart. Initially, controller 17 receives data from the first and the second sensor units (step 120). Next, the controller computes a desired minimum light level (SP) based on data from the first sensor unit 24 (step 122). The controller also determines a light level of total backlights projected on the LCD panel (PV) based on data from the second sensor unit (step 124). A control signal is determined based on the comparison of the light level of total backlights projected on the LCD panel (PV) with the desired minimum light level (SP) (step 126). If the light level of total backlights projected on the LCD panel is not adequate, the brightness of the active backlight is adjusted according to the difference between PV and SP (step 128). At the same time, the cooling level of the cooling device is also adjusted according to the difference between PV and SP (step 130). Alternatively, adjustment is only made when the difference between SP and PV is greater than a particular threshold.

Control System for Hybrid Daylight-Coupled Display with a Shutter

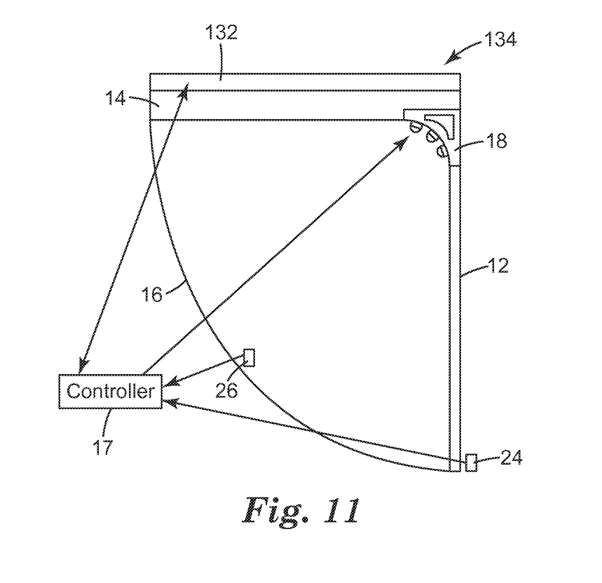

FIG. 11 is a side view of a hybrid daylight-coupled LCD device 134 with a control system and a shutter. Device 134 includes an LCD panel 12, a diffuser 14, a curved reflector 16, a first sensor unit 24, a second sensor unit 26, a controller 17, an active backlight 18, and a shutter 132. Shutter 132 is adjacent to the diffuser 14 and parallel to the diffuser 14. Shutter 132 can have various positions controlled by a motor, such as opened, closed, and partially opened, to control an amount of light passing through the diffuser. In one embodiment, shutter 132 can be a venetian blind with motor whose slats can be opened with an angle between 0° and 90° relative to the diffuser, where 0° is a closed position and 90° is a fully opened position. Controller 17 determines a control signal based on data from the first sensor unit 24 and the second sensor unit 26 and adjusts the power of active backlight according to the control signal, using the method of FIG. 3, for example. Controller 17 also controls the position of the shutter 132 based on the control signal. In one embodiment, shutter 132 may have an encoder associated with the motor and provide a feedback signal indicating the position of the shutter to the controller 17.

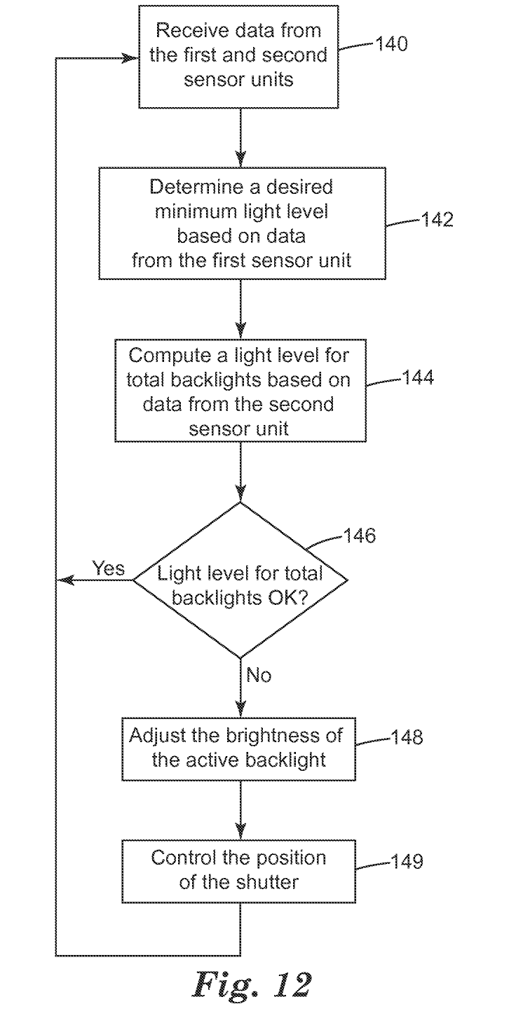

FIG. 12 illustrates an exemplary brightness control and shutter control flowchart. Initially, controller 17 receives data from the first and the second sensor units (step 140). Next, the controller computes a desired minimum light level (SP) based on data from the first sensor unit 24 (step 142). The controller also determines a light level of total backlights projected on the LCD panel (PV) based on data from the second sensor unit (step 144). A control signal is determined based on the comparison of the light level of total backlights projected on the LCD panel (PV) with the desired minimum light level (SP) (step 146). If the light level of total backlights projected on the LCD panel is not adequate, the brightness of the active backlight is adjusted according to the difference between PV and SP (step 148). At the same time, the position of the shutter is also adjusted according to the control signal (step 149). Alternatively, adjustment is only made when the difference between SP and PV is greater than a particular threshold. In an exemplary embodiment, shutter 132 is a venetian blind having slats whose angles are controllable by a motor and the controller 17 can reduce the angles of the slats relative to the diffuser when the active backlight is turned on.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A brightness control system for a hybrid daylight-coupled display, comprising:
an LCD panel having a top side and a bottom side;
an active backlight for providing active backlighting;
a diffuser having a front edge adjacent to the top side of the LCD panel and having a back edge;
a curved reflector having a top side adjacent to the back edge of the diffuser and having a bottom side adjacent to the bottom side of the LCD panel, wherein the diffuser transmits daylight to the reflector to provide passive backlighting and the active backlight transmits active backlight to the reflector, and wherein the reflector reflects backlights including the active backlight and the passive backlight to the LCD panel for providing backlighting;
a first sensor unit detecting the ambient light level surrounding the LCD panel;
a second sensor unit, positioned between the LCD panel and the curved reflector, detecting a light level for total backlights including the active backlight and the passive backlight; and
a processor determining a control signal based on data from the first and second sensor units and adjusting the active backlight's light level based on the control signal.

2. The system of claim 1, wherein a sensor unit comprises a plurality of sensors.

3. The system of claim 1, wherein the processor determines a desired minimum light level based on data from the first sensor unit, computes a light level for total backlights projected on the LCD panel based on data from the second sensor unit, and determines a control signal to adjust the light level of the active backlight to provide total backlights projected on the LCD panel above the desired minimum light level.

4. The system of claim 1, further comprising
a third sensor unit detecting an ambient light level at the back side of the hybrid daylight-coupled display, and
wherein the processor determines the control signal based on data from the first, second, and third sensor units.

5. The system of claim 2, wherein at least one of the sensors in the first and second sensor units is a photometric sensor.

6. The system of claim 1, wherein at least one of the first and second sensor units comprises a plurality of sensors, each of the plurality of sensors measures the power in a particular spectral range, and wherein the active backlight comprises a plurality of light sources, each of the plurality of light sources provides light in a similar spectral range to one of the plurality of sensors, and the power of each of the light sources is adjusted based on data from the sensors with similar spectral range.

7. The system of claim 1, wherein at least one of the first and second sensor units comprises a sensor measuring a display attribute of the LCD panel, and wherein the processor determines a control signal based on the display attribute measured by the sensor and adjusts the display attribute of the LCD panel according to the control signal.

8. The system of claim 7, wherein the display attribute comprises at least one of color temperature, hue, contrast ratio, and color saturation.

9. The system of claim 1, further comprising:
an active backlight cooling device; and
the processor adjusting cooling level of the active backlight cooling device based on the control signal.

10. The system of claim 1, further comprising:
a shutter adjacent to the diffuser, wherein the shutter has various positions that can be changed to control amount of light passing through the diffuser; and
the processor controlling the position of the shutter based on the control signal.

11. The system of claim 3, further comprising allowing a user to adjust the desired minimum light level.

12. A brightness control system for a hybrid daylight-coupled display having an LCD panel, a curved reflector, a diffuser transmitting daylight to the reflector and the reflector reflecting the daylight to the LCD panel for providing passive backlighting, and an active backlight for providing active backlighting, the system comprising:
a first sensor detecting the ambient light level surrounding the LCD panel;
a second sensor detecting a light level for total backlights including the active backlight and the passive backlight; and
a processor computing a control signal based on data from the first and second sensors and adjusting the active backlight's light level based on the control signal.

13. A method to control brightness for a hybrid daylight-coupled display having an LCD panel, a curved reflector, a diffuser, an active backlight, the method comprising:
providing active backlighting by an active backlight;
transmitting daylight to the reflector by the diffuser to provide passive backlighting;
reflecting backlights including the active backlight and the passive backlight to the LCD panel by the curved reflector;
detecting the ambient light level surrounding the LCD panel by a first sensor unit;
detecting a light level for total backlights including the active backlight and the passive backlight by a second sensor unit; and
determining, with a processor, a control signal based on data from the first and second sensor units and adjusting the active backlight's light level based on the control signal.

14. The method of claim 13, wherein a sensor unit comprises a plurality of sensors.

15. The method of claim 13, wherein the determining step comprises computing a desired minimum light level based on data from the first sensor unit, determining a light level of backlights projected on the LCD panel based on data from the second sensor unit, and determining a control signal to adjust the light level of the active backlight to provide total backlights projected on the LCD panel above the desired minimum light level.

16. The method of claim 13, wherein at least one of the sensors in the first and second sensor units is a photometric sensor.

17. The method of claim 13, wherein at least one of the first and second sensor units comprises a plurality of sensors, each of the plurality of sensors measures the power in a particular spectral range, and wherein the active backlight comprises a plurality of light sources, each of the plurality of light sources provides light in a similar spectral range to one of the plurality of sensors, and the power of each of the light sources is adjusted based on data from the sensors with similar spectral range.

18. The method of claim 13, further comprising
adjusting cooling level of an active backlight cooling device based on the control signal.

19. The method of claim 15, further comprising allowing a user to adjust the desired minimum light level.

20. A brightness control system for a hybrid daylight-coupled display comprising:
an LCD panel having a top side and a bottom side;
an active backlight for providing active backlighting;
a diffuser having a front edge adjacent to the top side of the LCD panel and having a back edge;
a first curved reflector having a top side adjacent to the back edge of the diffuser and having a bottom side adjacent to a mid-point of the LCD panel;
a second curved reflector having a top side adjacent to the back edge of the diffuser and having a bottom side adjacent to the bottom side of the LCD panel, wherein the diffuser transmits daylight to the first and second reflectors to provide passive backlighting and the active backlight transmits active backlight to the first and second reflectors, wherein the first reflector reflects backlight to a top portion of the LCD panel for providing backlighting, and wherein the second reflector receives light transmitted through the first reflector and reflects the light to a bottom portion of the LCD panel for providing backlighting;
a first sensor unit detecting the ambient light level surrounding the LCD panel;
a second sensor unit detecting a light level for the total backlight including the active backlight and passive backlight, which is located between the first reflector and the second reflector; and
a processor determining a control signal based on data from the first and second sensor units and adjusting the active backlight's light level based on the control signal.

21. The system of claim 20, wherein a sensor unit comprises a plurality of sensors.

22. The system of claim 20, wherein the processor determines a desired minimum light level based on data from the first sensor unit, computes a light level for total backlights projected on the LCD panel based on data from the second sensor unit, and determines a control signal to adjust the light level of the active backlight to provide total backlights projected on the LCD panel above the desired minimum light level.
